(19) United States
(12) Patent Application Publication
(10) Pub. No.: US 2020/0366973 A1
(43) Pub. Date: Nov. 19, 2020

(54) Automatic Video Preview Creation System

(71) Applicant: PCCW VUCLIP (SINGAPORE) PTE. LTD., Singapore (SG)

(72) Inventors: Kulbhushan Pachauri, Bangalore (IN); Bo Shen, Fremont, CA (US)

(21) Appl. No.: 16/412,179

(22) Filed: May 14, 2019

(51) Int. Cl. H04N 21/8549; G06K 9/00; G11B 27/031; H04N 21/414; H04N 21/234; H04N 21/233; H04N 21/25

(52) U.S. Cl. CPC H04N 21/8549; G06K 9/00751; G11B 27/031; H04N 21/251; H04N 21/23418; G06K 9/00302; H04N 21/233; H04N 21/41407

(57) ABSTRACT

A video preview creation system creates portrait-mode video previews from landscape-mode video content by analyzing video frames to find candidate segments for the video preview. The candidate segments are filtered to find frames that are desirable using quality-based rules. Filtered segments are then smart-cropped and stitched together to create the portrait video preview.

### TECHNICAL FIELD

Embodiments relate generally to electronic content publishing, and, more specifically, to techniques for automatically creating video previews of video files.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Online content distributors publish a variety of media content items to consumers. Published content items may range from amateur, user-uploaded video clips to high-quality television shows and movies. A content distributor publishes a content item by making the content item available electronically to client computing devices through one or more access mechanisms known as channels or sites. Such sites may include different web sites, web applications, mobile or desktop applications, online streaming channels, and so forth. A site may be hosted by the content distributor itself, or by another entity, such as an Internet Service Provider or web portal. A site may freely publish a content item to all client devices, or impose various access restrictions on the content item, such as requiring that the client device present credentials associated with a valid subscription that permits access to the content item, or requiring that the client device be accessing the site through a certain provider or within a certain geographic area.

A content distributor may distribute media content items produced by other entities, referred to herein as content providers. A content distributor may publish content that the distributor has stored within its own system on behalf of the content provider.

In order to provide users with a sense of the subject matter contained in content items, e.g., video content items, content providers and distributors attempt to create video summaries or previews that give the users a visual preview of portions of the content items in a shortened timespan. Some approaches randomly select segments of the content item and assemble the segments into a single presentation. Other approaches randomly access and display portions of the content items in real time. Yet other approaches select segments of the content item using time intervals or viewer interest statistics and assemble the segments into a single presentation.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram of an embodiment of the invention;

FIG. 2 is a block diagram of a video content item analysis, according to an embodiment;

FIG. 3 is an illustrative view of a video content item with identified segments, according to an embodiment;

FIG. 4 is a block diagram of a video preview creation system, according to an embodiment;

FIG. 5 is a block diagram of an extended video preview creation system, according to an embodiment;

FIG. 6 is an illustrative view a video frame with a selected crop area, according to an embodiment;

FIG. 7 is an illustrative view a series of video segments stitched together to form a video preview, according to an embodiment; and

FIG. 8 is block diagram of a computer system upon which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Embodiments are described herein according to the following outline:

1.0. General Overview

2.0. Structural Overview
2.1. Video Delivery System
2.2. Video Preview Creation

3.0. Implementation Mechanism—Hardware Overview

4.0. Extensions and Alternatives

### 1.0. General Overview

This overview presents a basic description of some aspects of possible embodiments of the present invention. It should be noted that this overview is not an extensive or exhaustive summary of aspects of the possible embodiment. Moreover, it should be noted that this overview is not intended to be understood as identifying any particularly significant aspects or elements of the possible embodiments, nor as delineating any scope of any possible embodiment in particular, nor the invention in general. This overview merely presents some concepts that relate to the example possible embodiment in a condensed and simplified format and should be understood as merely a conceptual prelude to a more detailed description of example possible embodiments that follows below.

In order to generate revenue tied to the consumption of content items, it is key for content providers and content distributors to have content items in their catalogs viewed by users. This requires that content providers and content distributors communicate to a user what content items are in their inventory for the user to consume. The content provider or content distributor can simply publish a catalog listing of the titles of content items that the content provider and content distributor has available for user consumption. Another method that a content provider and content distributor can communicate such content items is via icons or images for each individual content item in an attempt to inform, entice, and attract the attention of the user. Yet another method that a content provider and content distributor can use to inform, entice, and attract the attention of the user is via individual video previews.

A user of a video content provider or distributor does not have the time nor patience to begin viewing each content item in the content provider or content distributor's catalog that seems of interest to the user. As noted above, some type of preview is displayed to the user in order for the user to gather some impression of the subject matter of a particular content item. The quality of the preview, e.g., a video preview of a video content item, many times determines whether the user will engage the content item by selecting and viewing the content item. Prior approaches encountered problems with creating video previews that are engaging to users without involving human intervention in order to select portions of content items that can increase the frequency of user engagements with the content items themselves. Embodiments disclosed herein overcome these difficulties by automatically creating video summaries/previews of visual content items using novel analysis of frames in the video content. The embodiments automatically create short, interesting, video previews of video content items. These video previews drive higher user engagements and click-throughs by assisting users in finding content that is more attuned to their personal viewing interests.

Previews may be presented in either landscape or portrait mode. Studies have shown that 94% of the time, mobile users view and explore websites in portrait mode. Although portrait mode is discussed more frequently herein, the discussions also apply to landscape mode.

Most video content are captured in landscape mode, which means that one challenge is to create video previews tailored specifically for portrait mode from video content that have been originally captured and stored in landscape mode. Rather than simply shrinking the video frames to match the aspect ratio (which typically causes black horizontal and or vertical bars to be displayed), an embodiment preserves interesting regions of video frames in the video content items and presents them in the portrait mode preview.

An embodiment analyzes video frames to find candidate regions for the video preview. The candidate regions are filtered to find frames that are desirable using quality-based rules. Filtered frames are then stitched together to form a landscape video preview and the landscape preview is then smart-cropped to create the portrait preview.

### 2.0. Structural Overview

### 2.1 Video Delivery and Video Preview Creation System

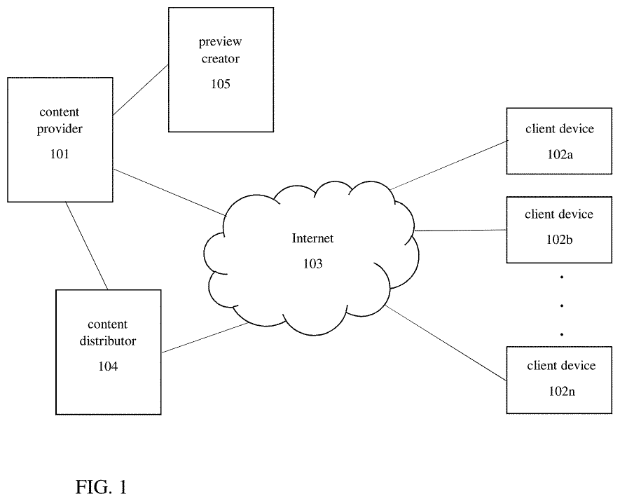

Referring to FIG. 1, a content provider server 101 as well as a content distributor 104 may consist of many servers such as in one or more server farms. The content provider server 101 distributes content to multiple client devices 102a-n and/or to a content distributor server 104. Content distributor server 104 distributes content to the multiple client devices 102a-n.

In an embodiment, content provider server 101 stores a plurality of video content items meant for user consumption along with a catalog of the video content items. Content distributor 104 has access to all or a portion of the catalog and video content items stored by the content provider server 101. In an embodiment, video previews may be created at the content provider server 101, content distributor server 104, and/or preview creator server 105. Note that preview creation may also be performed in the cloud using multi-tenant and virtual machine cloud services. Servers are discussed herein to provide clarity. Video previews of all or a portion of the video content items are also stored by the content provider 101 and/or content distributor 104. Video content files and video previews may be distributed to end users' client devices 102a-n across a network such as the Internet 103 via typical distribution channels through the content provider server 101 or content distributor server 104, e.g., web sites, torrent sites, social sites, etc.

As discussed above, when considering mobile device users, 94% of such users browse web sites and use mobile applications in portrait mode. In an embodiment, video previews are prepared with this in mind. When a user's client device is detected to be mobile device, content provider server 101 or content distributor server 104 delivers a portrait-oriented video preview of a content item to the user's client device. Video previews created at the content provider server 101, content distributor server 104, and/or preview creator server 105 include portrait-oriented video previews and, in some embodiments, include landscape-oriented video previews. In embodiments where both portrait-oriented video previews and landscape-oriented video previews are provided by the content provider server 101 or the content distributor server 104, the ability to send client devices 102a-n video previews dependent upon the orientation that the user is viewing the web page or mobile application is enabled.

### 2.2 Video Preview Creation

An embodiment creates a video preview that is coherent when translated from a video content item that has been recorded in landscape mode to a portrait mode video preview. In an embodiment, the video preview file is playable on any standard player, the container can be implemented using a standard format, e.g., MP4, MP3, 3GP, AVI, MKV, etc. Note that, although video formats are discussed in the following, any audio, textual, presentation, multimedia, etc., format may be used in alternate embodiments.

A video content item is analyzed by the content provider server 101, content distributor server 104, or preview creator server 105. For simplicity, the preview creator server 105 is discussed in detail, but the same operations may be equally performed by the content provider server 101 or content distributor server 104. The video content item may be retrieved by the preview creator server 105 from the video content items stored by content provider server 101.

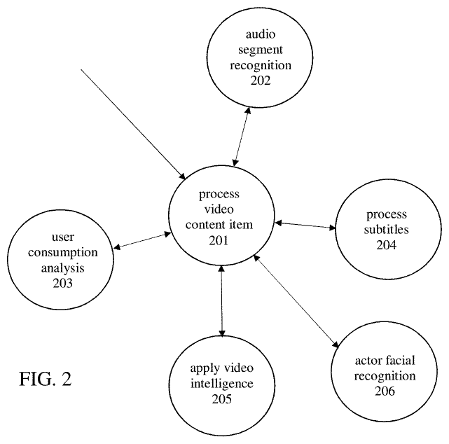

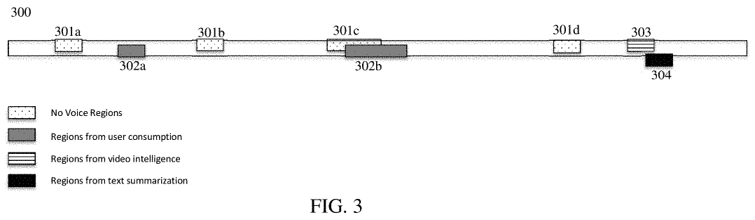

Referring to FIGS. 2 and 3, process video content item 201 uses one or more techniques to identify candidate video segments of a content items in order to accumulate enough candidate video segments to create a video preview. In an embodiment, the video preview typically does not contain an audio track. In order to achieve this, process video content item 201 processes the video content item to find segments in the video content item where there is no voice audio. Audio segment recognition 202 analyzes the audio track to find segments that do not contain voice audio. The audio is processed using a speech to text algorithm. The text conversion allows the system to evaluate what portions of the speech are voice. The candidate segments in the content item are identified, such as 301a-d, using the text analysis. Candidate segment identifiers (e.g., time stamps, timecodes, pointers, metadata, etc.) are sent to process video content item 201 by audio segment recognition 202.

Content provider server 101 has the ability to record user interactions with content items that are streamed to user client devices 102a-n. Interactions such a rewind, fast forward, jump forward/back, and pause, are typically user interactions that indicate whether segments of the content item are interesting or not interesting. Aggregating the data recorded for multiple users allows the system to determine interesting or popular segments in the content item. These interesting or popular segments can be candidate segments. Data aggregation may be performed for a content item or for a common content title given that there may be different versions of content items for a certain content title (e.g., different resolutions (e.g., SD, HD, 4k, etc.), having common video frames (e.g., director's cut, extended versions, etc.), etc.). User consumption analysis 203 analyzes the aggregated data for a content item and selects candidate segments based on the data. Candidate segment identifiers (e.g., time stamps, timecodes, pointers, metadata, etc.) are sent to process video content item 201 by user consumption analysis 203.

If subtitles are available in the content item, the audio segment recognition 202 analyzes the subtitles using process subtitles 204. In an embodiment, process subtitles 204 can use natural language processing to analyze subtitles in order to find the dominant text in the subtitles and evaluate importance of scenes. The dominant text can indicate which scenes may be key to the storyline. Key scenes are assumed to have important visual cues such as interactions with major characters in the movie or episode or the appearance of one or more of the major characters in the scene. Subtitles may also be used to identify candidate segments that do not contain voice audio, which supplements the audio analysis in audio segment recognition 202. Candidate segments, such as 304, are identified. Process subtitles 204 sends candidate segment identifiers (e.g., time stamps, timecodes, pointers, metadata, etc.) to process video content item 201.

In an embodiment, apply video intelligence 205 performs an audio/video analysis of the content item to identify actor action/emotion facial expressions, character keywords or phrases, segments that contain fighting/dancing/music, etc., which indicates the importance of the scene. Actor facial expressions, e.g., no lip movement, stressed areas around the mouth, etc., typically represents an emotional or strongly active or reactive event has occurred or is occurring. These facial expressions can indicate that no voice characteristics are likely evident in the segment for the character being analyzed. Certain character keywords or phrases may precede an action scene. Certain types of audio such as explosions, music, etc., may indicate that a scene is interesting. The candidate segments in the content item are identified, such as 303, using the audio and video analysis. The candidate segment identifiers (e.g., time stamps, timecodes, pointers, metadata, etc.) are sent to process video content item 201 by apply audio intelligence 205.

In an embodiment, facial recognition can be used to identify characters in the content item. Identifying which characters are the main characters or popular actors in the content item assists with the filtering of candidate segments. Some continuity may be achieved by stitching segments together that have a main character transitioning between scenes. Actor facial recognition 206 scans the content item to identify the characters in the content item. Main characters may be identified by the amount of screen time that the character has in the content item. A ranking of the characters identified in the content item is created along with the parameters of each character's facial features. As discussed in detail below, the characters' facial features are used to identify candidate segments that are selected for the video preview and are also used for cropping segments after selection.

As the candidate segments for the content item are identified using one or more of the techniques described above, process video content item 201 gathers the information for the candidate segments and determines if enough candidate segments have been identified to reasonably meet a specified threshold length of time for a video preview, e.g., 10 segments, 15 segments, 20 segments, etc. Process video content item 201 performs different set operations (intersection, union, etc.) on candidate segments in order to reach a selected set of candidate segments. Filtering rules are applied to the selected set of candidate segments. Upon reaching the threshold, the candidate segments are then filtered to determine which frames are useful for the video preview.

A set of filtering rules are applied to each candidate segment to filter out candidate segments. The set of rules includes any combination of:
If the ratio of face to frame area is greater than a certain threshold (e.g., zoomed in), the candidate segment is eliminated because the frame cannot be cropped to portrait mode. The frame may also cause the segment to look aesthetically unpleasing.
The percent of face time in the content item for the character is less than given threshold. This can indicate that the character is a minor character and would not contribute to the interest of the video preview.
Standard photography rules have been violated in the candidate segment, e.g., rule of third, colourfulness, dark frames, shallow depth of field, etc.
The candidate segment includes frames with lip movement. The lip movement is detected using facial landmark detection. Facial landmarks are located in the frame, such as areas around the lips, eyes, chin, etc., of faces in the frame.
The candidate segment includes visual logos or text in the frames. Logos and text will leave fragments in the frame after being cropped for portrait mode. If logos or text are present in the frame after cropping to portrait mode, then the segment may be removed.

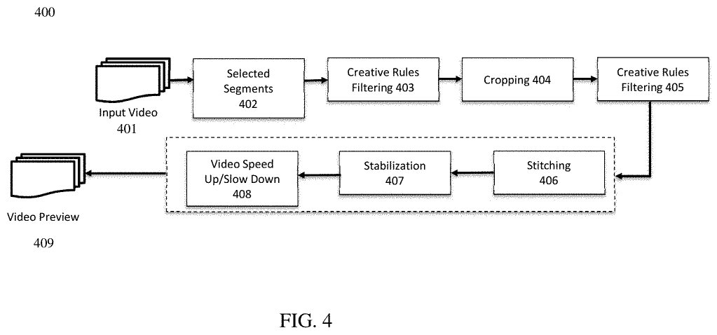

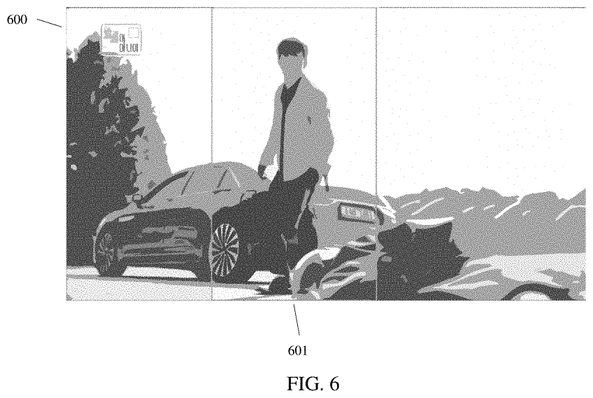

Referring to FIG. 4, the block diagram illustrates the processing steps that the candidate segments are subject to before being included in a video preview 409. As discussed above, once the candidate segments are gathered 402, the filtering rules are applied to each candidate segment in order to eliminate segments that will not contribute to the video preview 403. The filtered segments are then cropped 404 to adapt the landscape frame to a portrait frame. Referring to FIG. 6, a landscape mode frame 600 is shown. The area in the frame that one of the main characters is in is identified and the portion of the frame is selected 601 and cropped that adequately centers the character in the portrait mode frame. The frame cropping may be made to be visually pleasing using photography rules 405. For example, the semantic importance of each frame in selected segments are derived by video/audio/textual data analysis by one or more of:
Video analysis (e.g., unsupervised face clustering based on deep features, etc.), where main characters of videos are identified, same is used while cropping to preserve those main characters in case multiple faces present,
Using actor/actress profile images from metadata to preserve the main character while cropping (e.g., matching faces embedded in frames with actor/actress profile images from metadata).

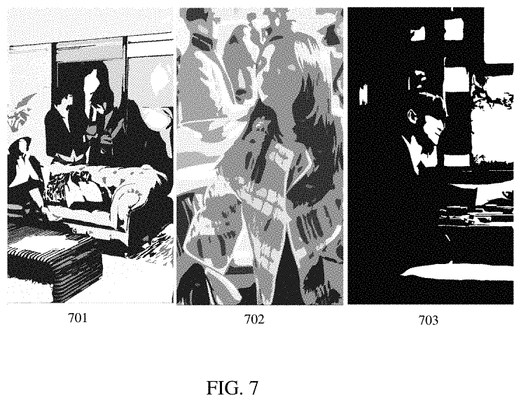

The cropped segments are stitched together 406 to form the video preview. Referring to FIG. 7, cropped segments 701, 702, and 703 are stitched together to form a video preview. In some embodiments, the video preview may need to be stabilized to remove unwanted shakiness to the video preview. The stabilization includes scene change detection along with face change detection (e.g., embedded face matching, etc.) to guide the video stabilization.

The video preview may be sped up (e.g., time compressed, etc.) or slowed down (e.g., frame repetition, etc.) if the duration of the video preview is greater or less than a target duration of the video preview 408. Optionally, video effects, such as, auto brightness, auto color correction, etc., may also be applied to the video preview before the video preview is finalized and stored 409.

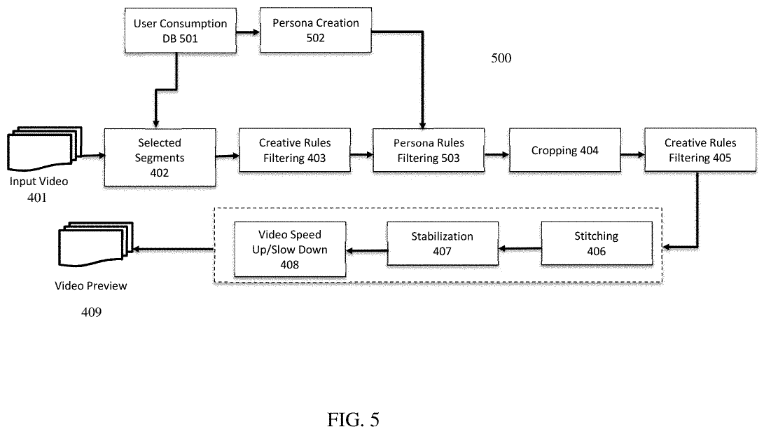

Referring to FIG. 5, another embodiment is shown that adds the ability to customize video previews using user or group personas. User consumption data is analyzed 501 in order to obtain user preferences. User data may be aggregated to create group personas 502. Frames may be selected with a bias toward the user preferences 503.

The persona feature enhances video previews by enabling multiple video previews to be created based on user data such as preferences for action, music, cars, sports, etc. A user can be grouped by prior experience that the user had with the content provider 101 or content distributor 104 or real-time characterization of user.

In an embodiment, the system can create video previews in real-time as the user is viewing other content in anticipation of the user's next view(s). Metadata for segments in a content item that have been previously filtered and selected for other video previews can be saved in order for the system to create video previews on the fly by combining selected regions based on the real-time evaluation of the user. Alternatively, when a video preview for a content item has not been created for a certain persona but one or more other video previews exist for other personas, the saved metadata can be used to create a new video preview for the certain persona. Thus, saving processing and response time, and ensuring that a user that falls in the certain persona is not presented with a video preview that does not match his persona.

Note that in the embodiments described in FIGS. 4 and 5, in yet another embodiment, before the selected segments are cropped 404, the segments may be stitched together to create a landscape video preview and the resultant video preview may be saved. Additionally, and/or optionally, the landscape preview may also be stabilized 407 and/or sped up or slowed down 408 as with portrait video previews. Having both portrait-oriented video previews and landscape-oriented video previews, the content provider server 101 or the content distributor server 104 can send client devices 102a-n video previews dependent upon the orientation that the user is viewing the web page or mobile application.

Video previews may be used for any purpose such as time fillers, teasers for a next episode or next content to be viewed, ads, etc.

In an embodiment, an apparatus comprises a processor and is configured to perform any of the foregoing methods.

In an embodiment, a non-transitory computer readable storage medium, storing software instructions, which when executed by one or more processors cause performance of any of the foregoing methods.

Note that, although separate embodiments are discussed herein, any combination of embodiments and/or partial embodiments discussed herein may be combined to form further embodiments.

### 3.0. Implementation Mechanism—Hardware Overview

According to one embodiment, the techniques described herein are implemented by one or more special-purpose computing devices. The special-purpose computing devices may be desktop computer systems, portable computer systems, handheld devices, smartphones, media devices, gaming consoles, networking devices, or any other device that incorporates hard-wired and/or program logic to implement the techniques. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques.

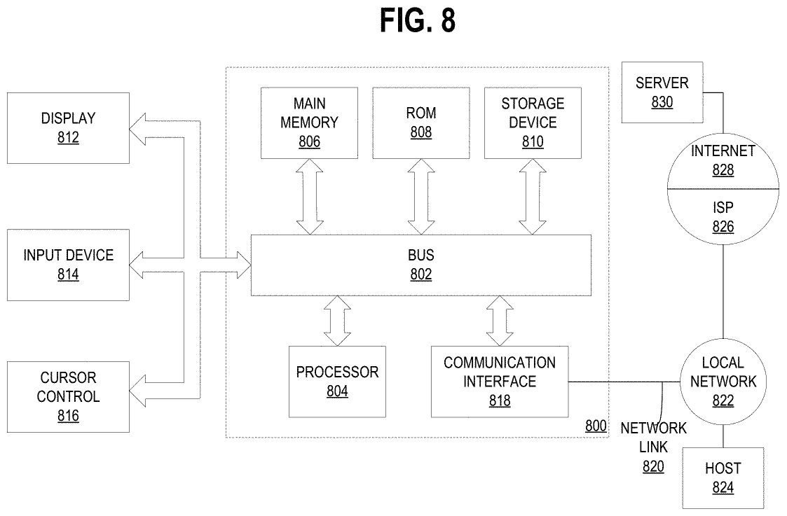

FIG. 8 is a block diagram that illustrates a computer system 800 utilized in implementing the above-described techniques, according to an embodiment. Computer system 800 may be, for example, a desktop computing device, laptop computing device, tablet, smartphone, server appliance, computing mainframe, multimedia device, handheld device, networking apparatus, or any other suitable device.

Computer system 800 includes one or more busses 802 or other communication mechanism for communicating information, and one or more hardware processors 804 coupled with busses 802 for processing information. Hardware processors 804 may be, for example, a general-purpose microprocessor. Busses 802 may include various internal and/or external components, including, without limitation, internal processor or memory busses, a Serial ATA bus, a PCI Express bus, a Universal Serial Bus, a HyperTransport bus, an Infiniband bus, and/or any other suitable wired or wireless communication channel.

Computer system 800 also includes a main memory 806, such as a random access memory (RAM) or other dynamic or volatile storage device, coupled to bus 802 for storing information and instructions to be executed by processor 804. Main memory 806 also may be used for storing temporary variables or other intermediate information during execution of instructions to be executed by processor 804. Such instructions, when stored in non-transitory storage media accessible to processor 804, render computer system 800 into a special-purpose machine that is customized to perform the operations specified in the instructions.

Computer system 800 further includes one or more read only memories (ROM) 808 or other static storage devices coupled to bus 802 for storing static information and instructions for processor 804. One or more storage devices 810, such as a solid-state drive (SSD), magnetic disk, optical disk, or other suitable non-volatile storage device, is provided and coupled to bus 802 for storing information and instructions.

Computer system 800 may be coupled via bus 802 to one or more displays 812 for presenting information to a computer user. For instance, computer system 800 may be connected via an High-Definition Multimedia Interface (HDMI) cable or other suitable cabling to a Liquid Crystal Display (LCD) monitor, and/or via a wireless connection such as peer-to-peer Wi-Fi Direct connection to a Light-Emitting Diode (LED) television. Other examples of suitable types of displays 812 may include, without limitation, plasma display devices, projectors, cathode ray tube (CRT) monitors, electronic paper, virtual reality headsets, braille terminal, and/or any other suitable device for outputting information to a computer user. In an embodiment, any suitable type of output device, such as, for instance, an audio speaker or printer, may be utilized instead of a display 812.

In an embodiment, output to display 812 may be accelerated by one or more graphics processing unit (GPUs) in computer system 800. A GPU may be, for example, a highly parallelized, multi-core floating point processing unit highly optimized to perform computing operations related to the display of graphics data, 3D data, and/or multimedia. In addition to computing image and/or video data directly for output to display 812, a GPU may also be used to render imagery or other video data off-screen, and read that data back into a program for off-screen image processing with very high performance. Various other computing tasks may be off-loaded from the processor 804 to the GPU.

One or more input devices 814 are coupled to bus 802 for communicating information and command selections to processor 804. One example of an input device 814 is a keyboard, including alphanumeric and other keys. Another type of user input device 814 is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane. Yet other examples of suitable input devices 814 include a touch-screen panel affixed to a display 812, cameras, microphones, accelerometers, motion detectors, and/or other sensors. In an embodiment, a network-based input device 814 may be utilized. In such an embodiment, user input and/or other information or commands may be relayed via routers and/or switches on a Local Area Network (LAN) or other suitable shared network, or via a peer-to-peer network, from the input device 814 to a network link 820 on the computer system 800.

A computer system 800 may implement techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor 804 executing one or more sequences of one or more instructions contained in main memory 806. Such instructions may be read into main memory 806 from another storage medium, such as storage device 810. Execution of the sequences of instructions contained in main memory 806 causes processor 804 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 810. Volatile media includes dynamic memory, such as main memory 806. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 802. Transmission media can also take the form of acoustic or light waves, such as those generated during radio-wave and infra-red data communications.

Various forms of media may be involved in carrying one or more sequences of one or more instructions to processor 804 for execution. For example, the instructions may initially be carried on a magnetic disk or solid state drive of a remote computer. The remote computer can load the instructions into its dynamic memory and use a modem to send the instructions over a network, such as a cable network or cellular network, as modulated signals. A modem local to computer system 800 can receive the data on the network and demodulate the signal to decode the transmitted instructions. Appropriate circuitry can then place the data on bus 802. Bus 802 carries the data to main memory 806, from which processor 804 retrieves and executes the instructions. The instructions received by main memory 806 may optionally be stored on storage device 810 either before or after execution by processor 804.

A computer system 800 may also include, in an embodiment, one or more communication interfaces 818 coupled to bus 802. A communication interface 818 provides a data communication coupling, typically two-way, to a network link 820 that is connected to a local network 822. For example, a communication interface 818 may be an integrated services digital network (ISDN) card, cable modem, satellite modem, or a modem to provide a data communication connection to a corresponding type of telephone line. As another example, the one or more communication interfaces 818 may include a local area network (LAN) card to provide a data communication connection to a compatible LAN. As yet another example, the one or more communication interfaces 818 may include a wireless network interface controller, such as a 802.11-based controller, Bluetooth controller, Long Term Evolution (LTE) modem, and/or other types of wireless interfaces. In any such implementation, communication interface 818 sends and receives electrical, electromagnetic, or optical signals that carry digital data streams representing various types of information.

Network link 820 typically provides data communication through one or more networks to other data devices. For example, network link 820 may provide a connection through local network 822 to a host computer 824 or to data equipment operated by a Service Provider 826. Service Provider 826, which may for example be an Internet Service Provider (ISP), in turn provides data communication services through a wide area network, such as the world wide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are example forms of transmission media.

In an embodiment, computer system 800 can send messages and receive data, including program code and/or other types of instructions, through the network(s), network link 820, and communication interface 818. In the Internet example, a server 830 might transmit a requested code for an application program through Internet 828, ISP 826, local network 822 and communication interface 818. The received code may be executed by processor 804 as it is received, and/or stored in storage device 810, or other non-volatile storage for later execution. As another example, information received via a network link 820 may be interpreted and/or processed by a software component of the computer system 800, such as a web browser, application, or server, which in turn issues instructions based thereon to a processor 804, possibly via an operating system and/or other intermediate layers of software components.

In an embodiment, some or all of the systems described herein may be or comprise server computer systems, including one or more computer systems 800 that collectively implement various components of the system as a set of server-side processes. The server computer systems may include web server, application server, database server, and/or other conventional server components that certain above-described components utilize to provide the described functionality. The server computer systems may receive network-based communications comprising input data from any of a variety of sources, including without limitation user-operated client computing devices such as desktop computers, tablets, or smartphones, remote sensing devices, and/or other server computer systems.

In an embodiment, certain server components may be implemented in full or in part using “cloud”-based components that are coupled to the systems by one or more networks, such as the Internet. The cloud-based components may expose interfaces by which they provide processing, storage, software, and/or other resources to other components of the systems. In an embodiment, the cloud-based components may be implemented by third-party entities, on behalf of another entity for whom the components are deployed. In other embodiments, however, the described systems may be implemented entirely by computer systems owned and operated by a single entity.

In an embodiment, an apparatus comprises a processor and is configured to perform any of the foregoing methods. In an embodiment, a non-transitory computer readable storage medium, storing software instructions, which when executed by one or more processors cause performance of any of the foregoing methods.

### 4.0. Extensions And Alternatives

As used herein, the terms “first,” “second,” “certain,” and “particular” are used as naming conventions to distinguish queries, plans, representations, steps, objects, devices, or other items from each other, so that these items may be referenced after they have been introduced. Unless otherwise specified herein, the use of these terms does not imply an ordering, timing, or any other characteristic of the referenced items.

In the drawings, the various components are depicted as being communicatively coupled to various other components by arrows. These arrows illustrate only certain examples of information flows between the components. Neither the direction of the arrows nor the lack of arrow lines between certain components should be interpreted as indicating the existence or absence of communication between the certain components themselves. Indeed, each component may feature a suitable communication interface by which the component may become communicatively coupled to other components as needed to accomplish any of the functions described herein.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. In this regard, although specific claim dependencies are set out in the claims of this application, it is to be noted that the features of the dependent claims of this application may be combined as appropriate with the features of other dependent claims and with the features of the independent claims of this application, and not merely according to the specific dependencies recited in the set of claims. Moreover, although separate embodiments are discussed herein, any combination of embodiments and/or partial embodiments discussed herein may be combined to form further embodiments.

Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method, comprising:
analyzing a landscape format video file for a plurality of segments that contain frames that have no voice characteristics;
filtering each segment in the plurality of segments for segments that can retain certain visual information after being cropped to portrait mode;
cropping each filtered segment to portrait format by including at least one character in the cropped filtered segment;
creating a video preview by stitching together each cropped filtered segment;
distributing the video preview to one or more mobile client devices.

2. The method of claim 1, further comprising:
creating a landscape video preview by stitching together each filtered segment.

3. The method of claim 1, further comprising:
creating a landscape video preview by stitching together each filtered segment;
distributing the landscape video preview to the one or more client devices, when the one or more client devices is in landscape viewing mode.

4. The method of claim 1, further comprising:
creating a landscape video preview by stitching together each filtered segment;
distributing the landscape video preview to the one or more client devices, when the one or more client devices is in landscape viewing mode;
wherein the distributing the video preview to the one or more mobile client devices distributes the video preview to the one or more mobile client devices, when the one or more client devices is in portrait viewing mode.

5. The method of claim 1, wherein the no voice characteristics includes one or more characters in each segment that is has no lip movement.

6. The method of claim 1, wherein the filtering each segment in the plurality of segments further comprises:
using facial recognition to identify characters in the landscape format video file;
identifying segments in the plurality of segments that includes one or more main characters.

7. The method of claim 1, wherein the filtering each segment in the plurality of segments further comprises:
analyzing subtitles in the landscape format video file to evaluate importance of scenes.

8. The method of claim 1, wherein the filtering each segment in the plurality of segments further comprises:
analyzing character facial expressions in the landscape format video file to evaluate importance of scenes.

9. The method of claim 1, wherein the filtering each segment in the plurality of segments further comprises:
analyzing audio present in the landscape format video file to evaluate importance of scenes.

10. The method of claim 1, wherein the filtering each segment in the plurality of segments further comprises:
analyzing aggregate viewer consumption patterns to evaluate importance of scenes.

11. One or more non-transitory computer-readable storage media, storing one or more sequences of instructions, which when executed by one or more processors cause performance of:
analyzing a landscape format video file for a plurality of segments that contain frames that have no voice characteristics;
filtering each segment in the plurality of segments for segments that can retain certain visual information after being cropped to portrait mode;
cropping each filtered segment to portrait format by including at least one character in the cropped filtered segment;
creating a video preview by stitching together each cropped filtered segment;
distributing the video preview to one or more mobile client devices.

12. The one or more non-transitory computer-readable storage media of claim 11, further comprising:
creating a landscape video preview by stitching together each filtered segment.

13. The one or more non-transitory computer-readable storage media of claim 11, further comprising:
creating a landscape video preview by stitching together each filtered segment;
distributing the landscape video preview to the one or more client devices, when the one or more client devices is in landscape viewing mode.

14. The one or more non-transitory computer-readable storage media of claim 11, further comprising:
creating a landscape video preview by stitching together each filtered segment;
distributing the landscape video preview to the one or more client devices, when the one or more client devices is in landscape viewing mode;
wherein the distributing the video preview to the one or more mobile client devices distributes the video preview to the one or more mobile client devices, when the one or more client devices is in portrait viewing mode.

15. The one or more non-transitory computer-readable storage media of claim 11, wherein the no voice characteristics includes one or more characters in each segment that is has no lip movement.

16. The one or more non-transitory computer-readable storage media of claim 11, wherein the filtering each segment in the plurality of segments further comprises:
using facial recognition to identify characters in the landscape format video file;
identifying segments in the plurality of segments that includes one or more main characters.

17. The one or more non-transitory computer-readable storage media of claim 11, wherein the filtering each segment in the plurality of segments further comprises:
analyzing subtitles or audio present in the landscape format video file to evaluate importance of scenes.

18. The one or more non-transitory computer-readable storage media of claim 11, wherein the filtering each segment in the plurality of segments further comprises:
analyzing character facial expressions in the landscape format video file to evaluate importance of scenes.

19. The one or more non-transitory computer-readable storage media of claim 11, wherein the filtering each segment in the plurality of segments further comprises:
analyzing aggregate viewer consumption patterns to evaluate importance of scenes.

20. An apparatus, comprising:
a video analysis device, implemented at least partially in hardware, configured to analyze a landscape format video file for a plurality of segments that contain frames that have no voice characteristics;
wherein the video analysis device filters each segment in the plurality of segments for segments that can retain certain visual information after being cropped to portrait mode;
a frame cropping device, implemented at least partially in hardware, configured to crop each filtered segment to portrait format by including at least one character in the cropped filtered segment;
a segment stitching device, implemented at least partially in hardware, configured to creating a video preview by stitching together each cropped filtered segment;
a video distribution device, implemented at least partially in hardware, configured to distribute the video preview to one or more mobile client devices.
